(19) United States
(12) Patent Application Publication
(10) Pub. No.: US 2013/0258380 A1
(43) Pub. Date: Oct. 3, 2013

(54) IMAGE FORMING APPARATUS ALLOWING REMOTE START, CONTROL METHOD THEREFOR, AND STORAGE MEDIUM STORING CONTROL PROGRAM THEREFOR

(71) Applicant: CANON KABUSHIKI KAISHA, Tokyo (JP)

(72) Inventor: Kohei ASANO, Yokohama-shi (JP)

(73) Assignee: CANON KABUSHIKI KAISHA, Tokyo (JP)

(21) Appl. No.: 13/798,559

(22) Filed: Mar. 13, 2013

(30) Foreign Application Priority Data
Mar. 30, 2012 (JP) 2012-080727

(51) Int. Cl. G06K 15/00

(52) U.S. Cl. CPC G06K 15/4055
USPC 358/1.13

(57) ABSTRACT

An image forming apparatus that is capable of reducing power consumption when a main power is OFF and of performing remote start without using an exclusive circuit. A power control unit supplies power to a main control unit and a communication module that communicates with an external apparatus. A first-communication-module-control unit controls the communication module to operate in a first operational mode in which the main control unit does not operate in a normal mode. A supply instruction unit instructs the power control unit to supply power for operating the main control unit in the normal mode, when the external apparatus instructs to start the image forming apparatus and the communication module operates in the first operational mode. A second-communication-module-control unit controls the communication module to operate in a second operational mode in which the main control unit operates in the normal mode.

### BACKGROUND OF THE INVENTION

1. Field of the Invention

The present invention relates to an image forming apparatus that allows a remote start according to an instruction from an external apparatus, a control method therefor, and a storage medium storing a control program therefor.

2. Description of the Related Art

In recent years, attention on an environmental problem is increasing every year and an energy saving technique is indispensable for every apparatus. An image forming apparatus has a mechanism that reduces power consumption according to an operating condition of the apparatus by a user.

There is a developed method of allowing remote start that controls ON/OFF of a main power supply by an external apparatus arranged in a remote place.

This method periodically applies electric power to a part (a power control unit) of an image forming apparatus even when the main power supply is in an OFF state so as to make an inquiry to a control apparatus at a remote place about whether the image forming apparatus itself should be started. When receiving a reply of a power-ON from the control apparatus, the entire system of the image forming apparatus is started.

Another method always applies electric power to a part (a remote power control unit) of an image forming apparatus even when a main power supply is in an OFF state. When receiving a power ON instruction from a remote place, the entire system of the image forming apparatus is started.

Since either method can turn on the power supply of the image forming apparatus from a remote place (remote start), it is effective not only in energy saving but also in a maintenance work from a remote place.

In order to enable a power control from a remote place, a power control unit needs to have a function to communicate with an external apparatus. In a common image forming apparatus, a communication control unit that has a network function like a LAN can be used as a remote power control unit by adding a control function of the power control unit.

However, since the communication control unit that allows packet communication with a network function has comparatively large circuit structure and consumes a lot of electric power, the power consumption of the image forming apparatus becomes large even when the main power supply is in an OFF state. There is a known technique that provides a small-scale bootstrap circuit specialized in recognition of a starting packet and shifts an image forming apparatus to a normal operational mode from a power saving operational mode when receiving a starting packet (for example, see Japanese Laid-Open Patent Publication (Kokai) No. 2009-253748 (JP 2009-253748A)).

However, since the technique disclosed in this publication needs to provide the exclusive bootstrap circuit in addition to the communication control unit that operates in a normal operational mode, the circuit configuration becomes complicated and the cost increases.

### SUMMARY OF THE INVENTION

The present invention provides an image forming apparatus, a control method therefor, and a storage medium storing a control program therefor, which are capable of reducing power consumption of the image forming apparatus when the main power supply is in the OFF state and of performing remote start without using an exclusive bootstrap circuit.

Accordingly, a first aspect of the present invention provides an image forming apparatus comprising a communication module configured to communicate with an external apparatus, a main control unit configured to control the image forming apparatus and to operate in a normal mode or a power saving mode that consumes less power than the normal mode, an electric power source control unit configured to supply electric power to the main control unit and the communication module, a first-communication-module-control unit configured to control the communication module so as to operate in a first operational mode in which communications are controlled in a state where the main control unit does not operate in the normal mode, a supply instruction unit configured to instruct the electric power source control unit to supply electric power for operating the main control unit in the normal mode, when the external apparatus instructs to start the image forming apparatus in a state where the communication module is operating in the first operational mode, and a second-communication-module-control unit configured to control the communication module so as to operate in a second operational mode in which communications are controlled in a state where the main control unit is operating in the normal mode, when the supply instruction unit instructs to supply the electric power for operating the main control unit in the normal mode.

Accordingly, a second aspect of the present invention provides a control method for an image forming apparatus that includes a communication module that communicates with an external apparatus, a main control unit that controls the image forming apparatus and operates in a normal mode or a power saving mode that consumes less power than the normal mode, and an electric power source control unit that supplies electric power to the main control unit and the communication module, comprising a first-communication-module-control step of controlling the communication module so as to operate in a first operational mode in which communications are controlled in a state where the main control unit does not operate in the normal mode, a supply instruction step of instructing the electric power source control unit to supply electric power for operating the main control unit in the normal mode, when the external apparatus instructs to start the image forming apparatus in a state where the communication module is operating in the first operational mode, and a second-communication-module-control step of controlling the communication module so as to operate in a second operational mode in which communications are controlled in a state where the main control unit is operating in the normal mode, when an instruction to supply the electric power for operating the main control unit in the normal mode is issued in the supply instruction step.

Accordingly, a third aspect of the present invention provides a non-transitory computer-readable storage medium storing a control program causing a computer to execute the control method according to the second aspect.

The present invention can provide the image forming apparatus, the control method therefor, and the storage medium storing the control program therefor, which are capable of reducing power consumption of the image forming apparatus when the main power supply is in the OFF state and of performing remote start without using an exclusive bootstrap circuit.

Further features of the present invention will become apparent from the following description of exemplary embodiments with reference to the attached drawings.

### BRIEF DESCRIPTION OF THE DRAWINGS

FIG. 1 is a block diagram schematically showing a configuration of an image forming apparatus according to a first embodiment of the present invention.

FIG. 2 is a block diagram schematically showing a configuration of a communication control unit in FIG. 1.

FIG. 3 is a block diagram schematically showing a configuration of a power supply unit in FIG. 1.

FIG. 4 is a flowchart showing a communication control starting process executed by a CPU of the communication control unit in FIG. 2.

FIG. 5 is a block diagram schematically showing a configuration of a communication control unit according to a second embodiment.

FIG. 6 is a flowchart showing a communication control starting process according to the second embodiment executed by a CPU of the communication control unit in FIG. 5.

FIG. 7 is a flowchart showing a communication control starting process according to a third embodiment executed by the CPU of the communication control unit in FIG. 5.

### DESCRIPTION OF THE EMBODIMENTS

Hereafter, embodiments according to the present invention will be described in detail with reference to the drawings.

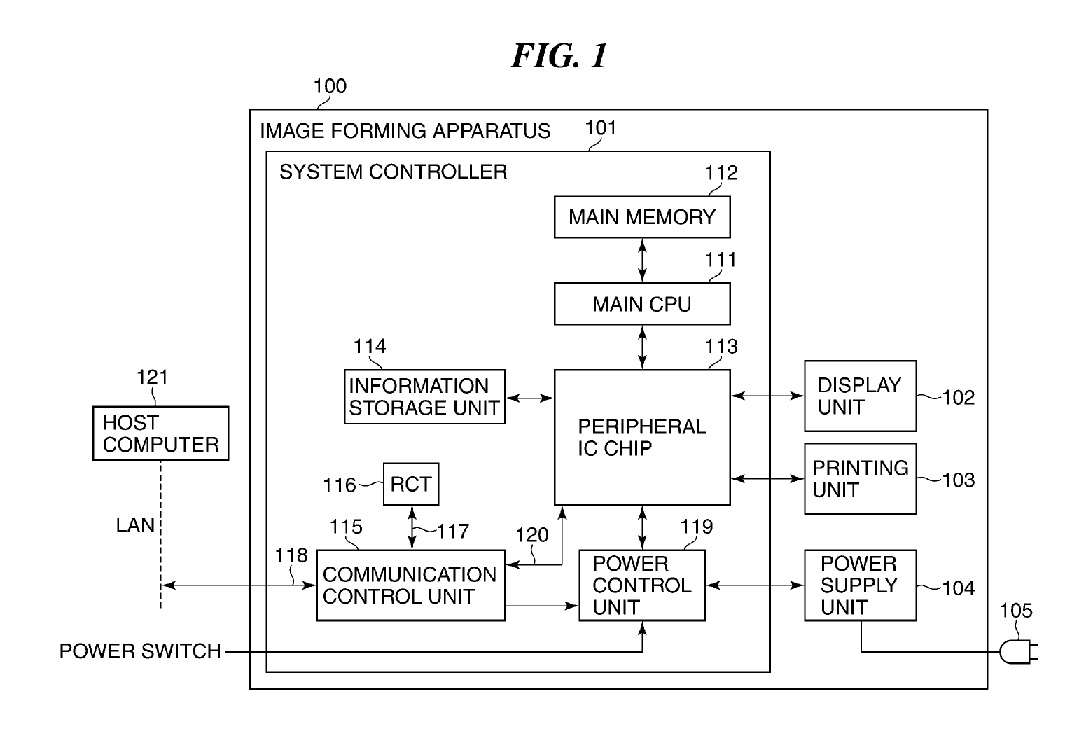

FIG. 1 is a block diagram schematically showing a configuration of an image forming apparatus 100 according to an embodiment of the present invention.

As shown in FIG. 1, the image forming apparatus 100 includes a system controller 101, a display unit 102, a printing unit 103, and a power supply unit 104.

The system controller 101 controls the entire image forming apparatus 100. The display unit 102 provides an interface to a user according to instructions from the system controller 101, and passes information inputted by the user to the system controller 101.

The printing unit 103 prints an image onto a sheet according to instructions from the system controller 101. The power supply unit 104 controls electric power supplied to the image forming apparatus 100 according to instructions from the system controller 101, and supplies the electric power acquired from an electric socket 105 to devices of the image forming apparatus 100.

The system controller 101 includes a main CPU (a main control unit) 111, a main memory 112, a peripheral 10 chip 113, an information storage unit 114, a communication control unit (a communication module) 115, an RTC 116, and a power control unit (an electric power source control unit) 119.

The main the CPU 111 controls the entire system controller 101 as a whole, and controls the entire image forming apparatus 100. The main memory 112 is used as a work area to which firmware executed by the main CPU 111 is developed.

The peripheral 10 chip 113 connects the main CPU 111 with the display unit 102, the printing unit 103, and other devices in the system controller 101.

The information storage unit 114 connects with the peripheral 10 chip 113 and stores the firmware that is used to operate the main CPU 111. The communication control unit 115 connects with the peripheral 10 chip 113 and controls network communications of the system controller 101.

The communication control unit 115 connects with an external host computer 121 via a LAN. The RTC 116 is a clock with an independent power supply, and can apply a timer interrupt to the communication control unit 115 at predetermined time intervals via a timer interrupt line 117.

The power control unit 119 connects with the power supply unit 104, and controls the current supply of the image forming apparatus 100. The power control unit 119 also connects with the peripheral IO chip 113, and can also be operated according to instructions from the main CPU 111. The power control unit 119 also connects with the communication control unit 115, and can also be operated according to instructions from the communication control unit 115.

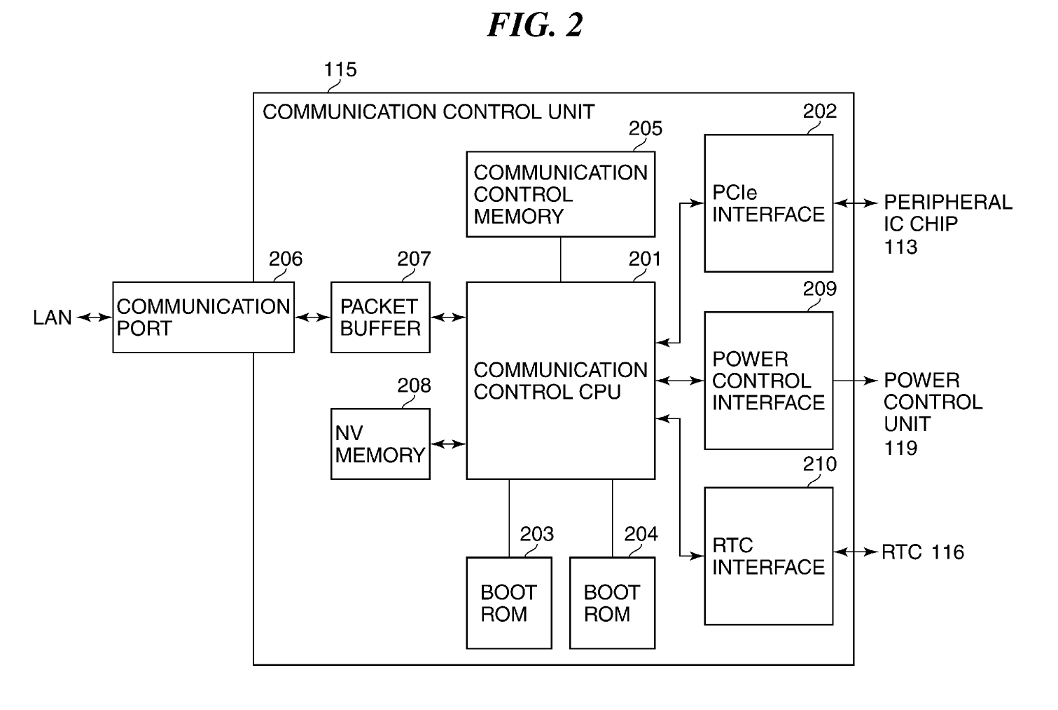

FIG. 2 is a view schematically showing the configuration of the communication control unit 115 in FIG. 1.

As shown in FIG. 2, a communication control CPU 201 controls the entire communications control unit 115. Moreover, the communication control CPU 201 also connects with the peripheral IO chip 113 via a PCIe interface 202, and can also communicate with the main CPU 111 and the other devices in the system controllers 101, and with the other devices, such as the printing unit 103, in the image forming apparatus 100.

Boot ROMs 203 and 204 stores firmware that is used to operate the communication control CPU 201. The boot ROMs 203 and 204 hold different kinds of the firmware, respectively.

The boot ROM 203 stores the firmware for a remote-ON mode that enables to be started by an instruction from a remote place. In this embodiment, such a technique for turning ON the image forming apparatus from a remote place is referred to as “remote ON” (remote start).

The boot ROM 204 stores the firmware for a normal operational mode that enables the image forming apparatus 100 to operate as the communication control unit 115 when operating normally.

A communication control memory 205 is used as a work area of the communication control CPU 201 to which the firmware read from the boot ROM 203 or the boot ROM 204 is developed.

A communication port 206 is a connector for connecting the LAN with the communications control unit 115. A packet buffer 207 is arranged between the communication control CPU 201 and the communication port 206, and can temporarily suspend a packet that flows on the network.

An NV memory 208 is a nonvolatile memory that stores set values (an IP address, a server address, etc.) that are used by the communication control CPU 201.

A power control interface 209 is an interface between the power control unit 119 and the communication control CPU 201. An RTC interface 210 is an interface between the communication control CPU 201 and the RTC 116.

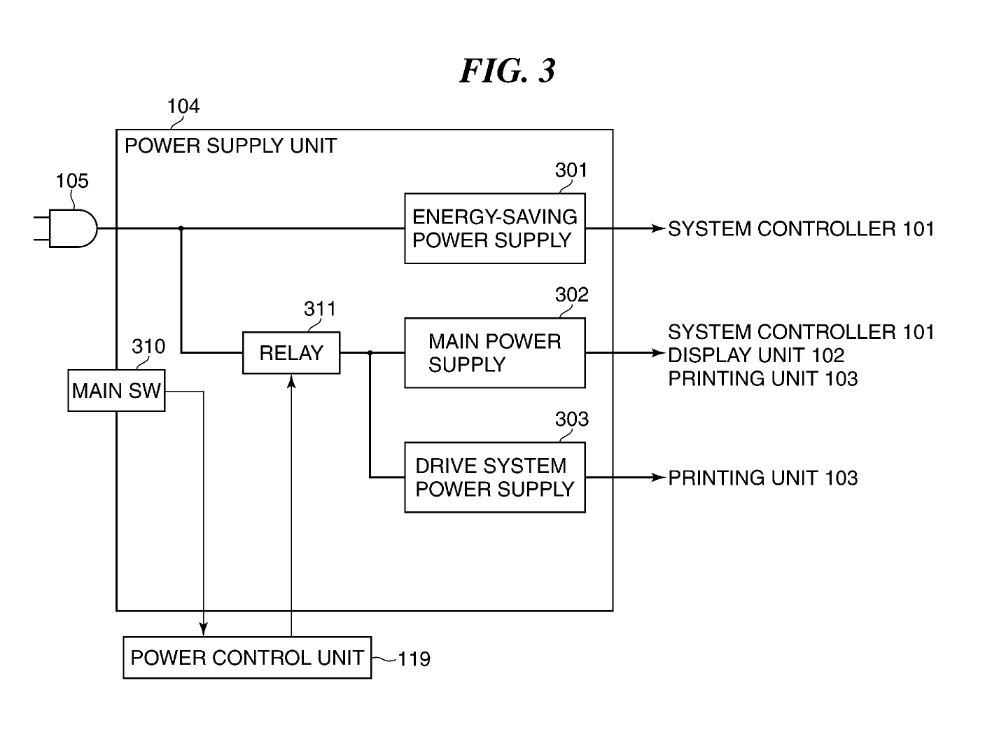

FIG. 3 is a view schematically showing a configuration of the power supply unit 104 in FIG. 1.

The power supply unit 104 includes an energy-saving power supply 301, a main power supply 302, and a drive system power supply 303 that are AC/DC converters, and includes a main switch 310 and a relay 311.

The secondary side of the energy-saving power supply 301 is connected to the system controller 101. The energy-saving power supply 301 supplies the electric power to the secondary side whenever the electric power is supplied to the electric socket 105. The energy-saving power supply 301 supplies the electric power to devices that operate during operation of the image forming apparatus 100 in a power saving mode. The energy-saving power supply 301 supplies the electric power to the communication control unit 115, for example.

The secondary side of the main power supply 302 is connected to the system controller 101, the display unit 102, and the printing unit 103. The main power supply 302 supplies the electric power to devices that operate during operation of the image forming apparatus 100 in the normal mode. Thus, the main CPU 111 controls the image forming apparatus 100 and operates in the normal mode or the power saving mode that consumes less electric power than the normal mode.

The secondary side of the drive system power supply 303 is connected to the printing unit 103. The drive system power supply 303 supplies the electric power to drive-system devices, such as motors, which operate only when printing.

The main switch 310 is a power switch for starting the image forming apparatus 100 by a user. The relay 311 supplies or intercepts the primary side power to the main power supply 302 and the drive system power supply 303 in response to instructions from the power control unit 119.

When a user operates the main switch and the image forming apparatus 100 starts, the power control unit 119 recognizes that the main switch 310 turns on, and drives the relay 311. As a result, the main power supply 302 and the drive system power supply 303 turn on and supply the electric power to the system controller 101 and it starts.

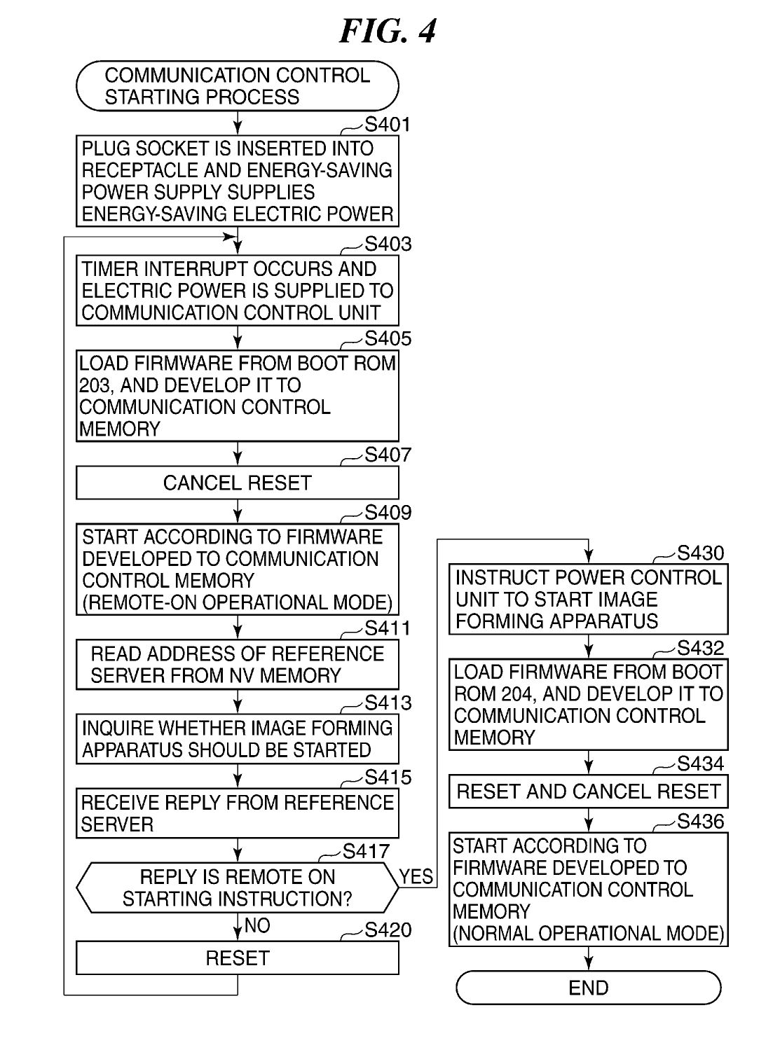

FIG. 4 is a flowchart showing a communication control starting process executed by the communication control CPU 201 in FIG. 2.

As shown in FIG. 4, when the plug socket 105 of the image forming apparatus 100 is inserted into a receptacle and the electric power is supplied to the plug socket 105, the energy-saving power supply 301 performs AC/DC conversion and supplies energy-saving electric power (step S401). Thereby, the energy-saving electric power is supplied to the communication control unit 115.

When the RTC generates a timer interrupt, the electric power is supplied to the communication control unit 115 that received the interrupt (step S403). The timer interrupt interval is set to the RTC 116 at the time of factory shipments. Then, when the time during which the electric power is not supplied to the plug socket 105 is longer than the timer interrupt interval set to the RTC 116, the timer interrupt continues to occur even before the plug socket 105 is inserted into a receptacle. Accordingly, the communications control unit 115 starts shortly after the plug socket 105 is inserted into a receptacle.

Next, the communication control CPU 201 loads the firmware in the designated address of the boot ROM 203, and develops it to the communication control memory 205 (step S405).

Since the operation here is automatically executed by a hardware logic unit that is built in the communication control CPU 201 when the communication control CPU 201 starts, it is not affected by the condition of the communication control CPU 201.

When the data is developed onto the communication control memory 205, the communication control CPU 201 cancels its reset (step S407).

When the reset of the communication control CPU 201 is canceled, the communication control CPU 201 starts in the remote ON operational mode according to the firmware developed onto the communication control memory 205 (step S409). This remote ON operational mode corresponds to a first operational mode in which communications are controlled in the state where the main CPU 111 does not operate in the normal mode. Accordingly, the step S409 corresponds to a first communication-module-control unit that controls the communication control unit 115 so as to operate in the first operational mode.

The communication control CPU 201 reads an address of a reference server (an external apparatus) from the NV memory 208 (step S411). Then, the communication control CPU 201 inquires whether the image forming apparatus 100 should be started (step S413), and receives a reply from the reference server (step S415).

Next, the communication control CPU 201 determines whether the reply is a remote ON starting instruction (step S417). When the reply is not a remote ON starting instruction (NO in the step S417), the communication control CPU 201 resets itself to suspend the operation (step S420), and returns the process to the step S403.

As a result, the image forming apparatus 100 waits for the next timer interrupt by the RTC 116 in a power OFF state.

On the other hand, when the reply is a remote ON starting instruction (YES in the step S417), the communication control CPU 201 instructs starting of the image forming apparatus 100 to the power control unit 119 (step S430). Thereby, the power control unit 119 drives the relay 311 of the power supply unit 104 to start the image forming apparatus 100 in the same manner as the case where the main switch is turned on. The above-mentioned step S430 corresponds to a supply instruction unit that instructs the power control unit 119 to supply the electric power for operating the main CPU 111 in the normal mode when the reference server instructs to start the image forming apparatus 100.

When the power control unit 119 is instructed to start the image forming apparatus 100, the communication control unit 115 starts to shift to the normal operational mode.

First, the communication control CPU 201 loads the firmware in the designated address of the boot ROM 204, and develops it to the communication control memory 205 (step S432).

Then, the communication control CPU 201 resets itself, cancels the reset immediately after that (step S434) to be started in the normal operational mode according to the firmware developed to the communication control memory 205 (step S436), and finishes this process. This normal operational mode corresponds to a second operational mode in which the main CPU 111 controls communications under operation in the normal mode. Accordingly, the step S436 corresponds to a second-communication-module-control unit that controls the communication control unit 115 so as to operate in the second operational mode. Moreover, the steps S409 through S430 corresponds to the state of the image forming apparatus 100 after the electric power is supplied until the operation in the normal mode starts, among the states in which the main CPU 111 is not operating in the normal mode.

According to the communication control starting process in FIG. 4, the communication control unit 115 is controlled so as to operate in the first operational mode in which communications are controlled in the state where the main CPU 111 does not operate in the normal mode. Then, when the reference server instructs to start the image forming apparatus 100 under the condition where the communication control unit 115 is operating in the first operational mode, the power control unit 119 is instructed to supply the electric power for operating the main CPU 111 in the normal mode. Moreover, when the reference server instructs to supply the electric power for operating the main CPU 111 in the normal mode, the communication control unit 115 is controlled so that the main CPU 111 operates in the second operational mode in which the main CPU 111 controls the communications in the normal mode. As a result, the communications are appropriately controllable with reference to the state of the image forming apparatus.

As described above, according to the embodiment, the communication control unit 115 operates in the remote-ON mode when the plug socket 105 of the image forming apparatus 100 is inserted into the receptacle, and shifts to the normal operational mode after the image forming apparatus 100 starts in response to the remote-ON instruction. Thereby, since the two modes are given to the communication control unit 115, it can be operated appropriately and the modes can be changed appropriately. Since the first operational mode is sufficient for an inquiry to the reference server and a reception of a reply, the power consumption of the communication control unit 115 is comparatively little. Accordingly, the power consumption in the power saving mode can be reduced without providing an exclusive bootstrap circuit.

Next, a second embodiment will be described. An image forming apparatus 100 in the second embodiment is different from that of the first embodiment in a point of a communication control unit 115 described below.

The communication control unit 115 is connected to the main CPU 111 through the PCIe interface 202 in the first embodiment. Although the communication control unit 115 can communicate with the main CPU 111, it is not communicating before and after starting in the first embodiment.

However, if the communication control unit 115 communicates before and after starting the main CPU 111, it is also possible to detect the anomalies of the main CPU 111 and to cope with it. The second embodiment describes an example that gives the communication control unit 115 a role of surveillance of the main CPU 111.

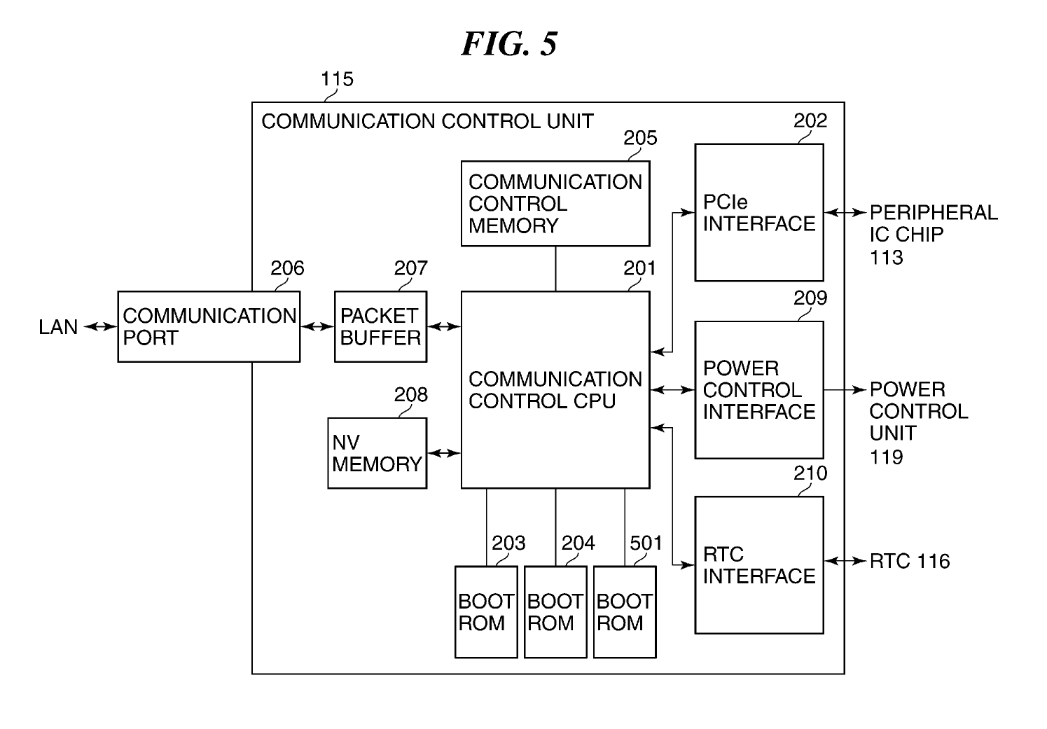

FIG. 5 is a view schematically showing a configuration of the communication control unit 115 according to the second embodiment.

As shown in FIG. 5, the communication control unit 115 in the second embodiment is different from that in the first embodiment in a point that a boot ROM 501 is newly provided and is connected to the communication control CPU 201.

The boot ROM 501 stores firmware for using the communication control unit 115 as a monitoring device for the main CPU 111.

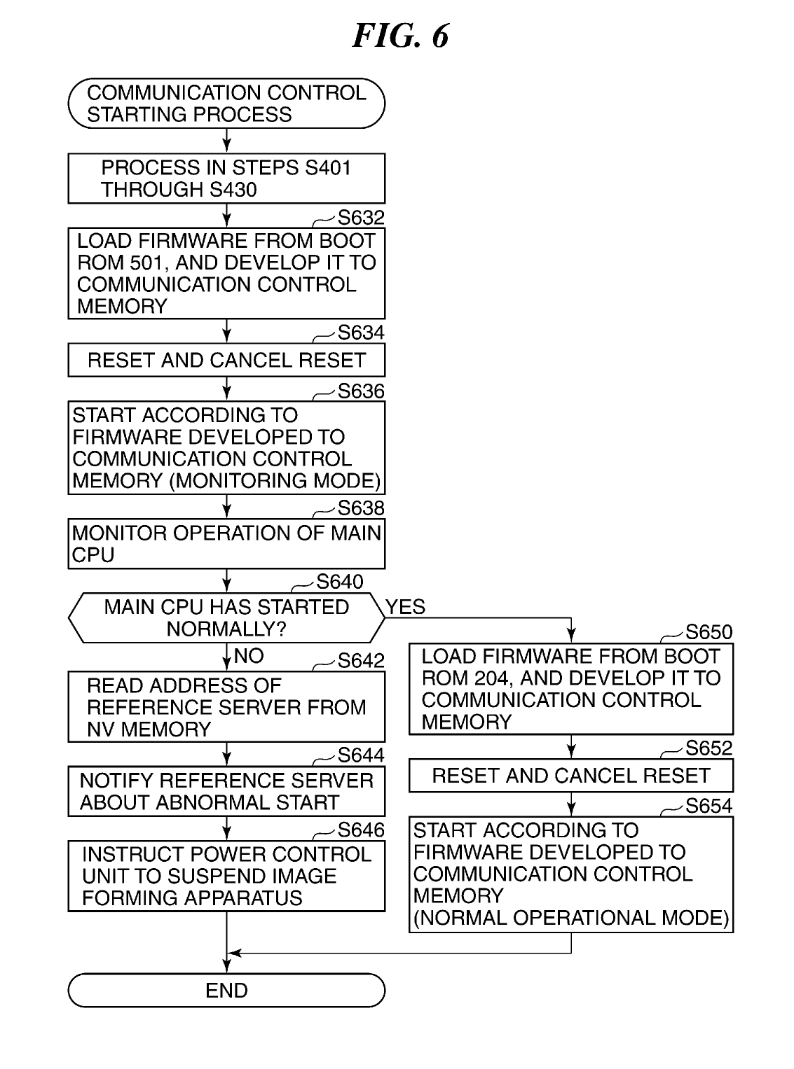

FIG. 6 is a flowchart showing a communication control starting process according to the second embodiment executed by the communication control CPU 201 in FIG. 5.

As shown in FIG. 6, the process in the steps S401 through 5430 in FIG. 4 is executed first.

Next, the communication control CPU 201 loads the firmware in the designated address of the boot ROM 501, and develops it to the communication control memory 205 (step S632).

Then, the communication control CPU 201 resets itself, cancels the reset immediately after that (step S634) to be started according to the firmware developed to the communication control memory 205 (step S636), and enters into a monitoring mode.

The communication control unit 115 monitors the operation state of the main CPU 111 through the peripheral IO chip 113 (step S638). This step S638 corresponds to a monitoring unit that monitors about whether the main CPU 111 is operating normally, when an instruction to supply the electric power for the operation in the normal mode is received.

Next, the communication control unit 115 determines whether the main CPU 111 has started normally (step S640). When the main CPU 111 has not started normally (NO in the step S640), the communication control unit 115 determines that anomalies occurred in starting of the image forming apparatus 100.

The communication control CPU 201 reads the address of the reference server from the NV memory 208 (step S642), and notifies that the image forming apparatus 100 has started abnormally (step S644).

Then, the communication control CPU 201 instructs the power control unit 119 to suspend the image forming apparatus 100 by turning the relay 311 off (step S646), and finishes this process.

On the other hand, when the main CPU 111 has started normally (YES in the step S640), the communication control unit 115 determines that the image forming apparatus 100 has successfully started.

Then, the communication control CPU 201 starts an operation for shifting the communication control unit 115 to the normal operational mode. First, the communication control CPU 201 loads the firmware in the designated address of the boot ROM 204, and develops it to the communication control memory 205 (step S650).

Then, the communication control CPU 201 resets itself, cancels the reset immediately after that (step S652) to be started in the normal operational mode according to the firmware developed to the communication control memory 205 (step S654), and finishes this process. Thus, when determining that the main CPU 111 is operating normally by monitoring, the communication control CPU 201 controls the communication control unit 115 to operate in the second operational mode. On the other hand, when determining that the main CPU 111 was not operating normally, the communication control CPU 201 instructs the power control unit 119 to prohibit supply of the electric power to the main CPU 111.

As described above, according to the second embodiment, the communication control unit 115 can monitor the normal starting after instructing the remote ON of the image forming apparatus 100. When the image forming apparatus 100 has not started normally, a notice is sent to the reference server, which informs the anomaly to the user at the remote place who instructed the remote ON. Moreover, the image forming apparatus 100 is not left in the abnormal state by instructing the power control unit 119 to suspend the image forming apparatus 100.

Next, a third embodiment will be described. Although a configuration of an image forming apparatus 100 in the third embodiment is the same as the configuration described in the second embodiment, the boot ROM 203 stores firmware for the power saving operational mode. Moreover, the NV memory 208 additionally stores map data for analyzing a packet received during a power saving operation.

The first embodiment and the second embodiment describe the image forming apparatus 100 that starts from the power OFF state. In that case, the electric power is supplied to only the communication control unit 115, and the image forming apparatus 100 is started by using the communication control unit 115 as a trigger.

Thus, the operation for supplying the electric power to only the communication control unit 115 and for starting the image forming apparatus 100 by using the communication control unit 115 as a trigger is the same as the return from the power saving mode in the image forming apparatus 100.

Moreover, the power supplying state of the image forming apparatus 100 where the electric power is supplied to only the energy-saving power supply 301, the communication control unit 115, and the power control unit 119, is the same as the first embodiment and the second embodiment.

Accordingly, the third embodiment will describe an example that changes the operational mode of the communication control unit 115 when the image forming apparatus 100 returns from the power saving mode.

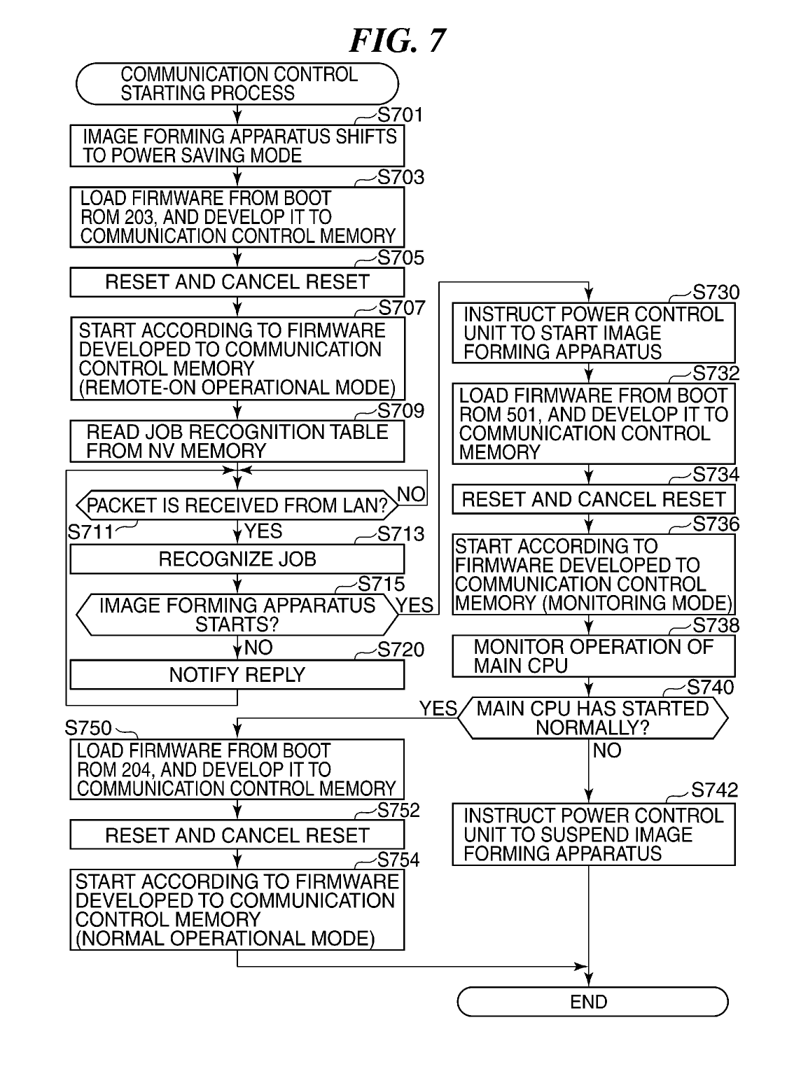

FIG. 7 is a flowchart showing a communication control starting process according to the third embodiment executed by the communication control CPU 201 in FIG. 5.

As shown in FIG. 7, when the image forming apparatus 100 shifts to the power saving mode (step S701), the communication control unit 115 starts to shift from the normal operational mode to the power saving operational mode.

Next, the communication control CPU 201 loads the firmware in the designated address of the boot ROM 203, and develops it to the communication control memory 205 (step S703).

Then, the communication control CPU 201 resets itself, cancels the reset immediately after that (step S7005) to be started according to the firmware developed to the communication control memory 205 (step S707), and enters into the power saving operational mode.

In the power saving operational mode, the communication control CPU 201 analyzes a packet received from the LAN, and determines whether the image forming apparatus 100 should be started or the communication control CPU 201 can process alone.

The communication control CPU 201 reads a job recognition table used for this analysis from the NV memory 208 to the communication control memory 205 (step S709), and waits until a packet is received from the LAN (step S711).

Next, when a packet is received from the LAN (YES in the step S711), the communication control CPU 201 develops the information about the packet to the communication control memory 205, and recognizes a job using the job recognition table (step S713).

Next, the communication control CPU 201 determines whether or not to start the image forming apparatus 100 based on the job analysis result (step S715).

When determining not to start the image forming apparatus 100 (NO in the step S715), the communication control CPU 201 replies in response to the packet (step S720), and returns the process to the step S711.

On the other hand, when determining to start the image forming apparatus 100 (YES in the step S715), the communication control CPU 201 instructs the power control unit 119 to start the image forming apparatus 100 (step S730). Thereby, the power control unit 119 drives the relay 311 of the power supply unit 104 to start the image forming apparatus 100 in the same manner as the case where the main switch is turned on.

Next, the communication control CPU 201 loads the firmware in the designated address of the boot ROM 501, and develops it to the communication control memory 205 (step S732).

Then, the communication control CPU 201 resets itself, cancels the reset immediately after that (step S734) to be started according to the firmware developed to the communication control memory 205 (step S736), and enters into the monitoring mode. The state in the steps S707 through 5734 corresponds to the state of the image forming apparatus is operating in the power saving mode, among the states in which the main CPU 111 does not operate in the normal mode.

The communication control unit 115 in the monitoring mode monitors the operation state of the main CPU 111 through the peripheral IO chip 113 (step S738).

Next, the communication control unit 115 determines whether the main CPU 111 has started normally (step S740). When the main CPU 111 has not started normally (NO in the step S740), the communication control unit 115 determines that anomalies occurred in starting of the image forming apparatus 100.

Then, the communication control CPU 201 instructs the power control unit 119 to suspend the image forming apparatus 100 by turning the relay 311 off (step 5742), and finishes this process.

On the other hand, when the main CPU 111 has started normally (YES in the step S740), the communication control unit 115 determines that the image forming apparatus 100 has successfully started.

Then, the communication control CPU 201 starts an operation for shifting the communication control unit 115 to the normal operational mode. First, the communication control CPU 201 loads the firmware in the designated address of the boot ROM 204, and develops it to the communication control memory 205 (step S750).

Then, the communication control CPU 201 resets itself, cancels the reset immediately after that (step S752) to be started in the normal operational mode according to the firmware developed to the communication control memory 205 (step S754), and finishes this process.

As described above, according to the third embodiment, the communication control unit 115 can change the operational mode appropriately even when the image forming apparatus 100 returns from the power saving operation. Furthermore, since the monitoring mode can be added to the operational modes of the communication control unit 115, it can monitor about whether the image forming apparatus returns from the power saving operation normally. That is, the image forming apparatus 100 is not left in the abnormal state when the image forming apparatus 100 returns from the power saving operation.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-080727, filed on Mar. 30, 2012, which is hereby incorporated by reference herein in its entirety.

What is claimed is:

1. An image forming apparatus comprising:
a communication module configured to communicate with an external apparatus;
a main control unit configured to control the image forming apparatus and to operate in a normal mode or a power saving mode that consumes less power than the normal mode;
an electric power source control unit configured to supply electric power to said main control unit and said communication module;
a first-communication-module-control unit configured to control said communication module so as to operate in a first operational mode in which communications are controlled in a state where said main control unit does not operate in the normal mode;
a supply instruction unit configured to instruct said electric power source control unit to supply electric power for operating said main control unit in the normal mode, when the external apparatus instructs to start the image forming apparatus in a state where said communication module is operating in the first operational mode; and
a second-communication-module-control unit configured to control said communication module so as to operate in a second operational mode in which communications are controlled in a state where said main control unit is operating in the normal mode, when said supply instruction unit instructs to supply the electric power for operating said main control unit in the normal mode.

2. The image forming apparatus according to claim 1, further comprising a monitoring unit configured to monitor about whether said main control unit is operating normally when said supply instruction unit instruct to supply the electric power for operating said main control unit in the normal mode, and
wherein said second-communication-module-control unit controls said communication module to operate in the second operational mode when said monitoring module determines that said main control unit is operating normally, and said supply instruction unit instructs said electric power source control unit to prohibit supply of the electric power to said main control unit when said monitoring module determines that said main control unit is not operating normally.

3. The image forming apparatus according to claim 1, wherein the state where said main control unit is not operating in the normal mode corresponds to a state where the image forming apparatus is operating in the power saving mode.

4. The image forming apparatus according to claim 1, wherein the state where said main control unit is not operating in the normal mode corresponds to a state of the image forming apparatus after the electric power is supplied until the operation in the normal mode starts.

5. A control method for an image forming apparatus that includes a communication module that communicates with an external apparatus, a main control unit that controls the image forming apparatus and operates in a normal mode or a power saving mode that consumes less power than the normal mode, and an electric power source control unit that supplies electric power to the main control unit and the communication module, the control method comprising:
a first-communication-module-control step of controlling the communication module so as to operate in a first operational mode in which communications are controlled in a state where the main control unit does not operate in the normal mode;
a supply instruction step of instructing the electric power source control unit to supply electric power for operating the main control unit in the normal mode, when the external apparatus instructs to start the image forming apparatus in a state where the communication module is operating in the first operational mode; and
a second-communication-module-control step of controlling the communication module so as to operate in a second operational mode in which communications are controlled in a state where the main control unit is operating in the normal mode, when an instruction to supply the electric power for operating said main control unit in the normal mode is issued in said supply instruction step.

6. A non-transitory computer-readable storage medium storing a control program causing a computer to execute a control method for an image forming apparatus that includes a communication module that communicates with an external apparatus, a main control unit that controls the image forming apparatus and operates in a normal mode a power saving mode that consumes less power than the normal mode, and an electric power source control unit that supplies electric power to the main control unit and the communication module, the control method comprising:
a first-communication-module-control step of controlling the communication module so as to operate in a first operational mode in which communications are controlled in a state where the main control unit does not operate in the normal mode;
a supply instruction step of instructing the electric power source control unit to supply electric power for operating the main control unit in the normal mode, when the external apparatus instructs to start the image forming apparatus in a state where the communication module is operating in the first operational mode; and
a second-communication-module-control step of controlling the communication module so as to operate in a second operational mode in which communications are controlled in a state where the main control unit is operating in the normal mode, when an instruction to supply the electric power for operating said main control unit in the normal mode is issued in said supply instruction step.
